(19) United States
(12) Patent Application Publication
(10) Pub. No.: US 2003/0126416 A1
(43) Pub. Date: Jul. 3, 2003

(54) Suspending execution of a thread in a multi-threaded processor

(76) Inventors: Deborah T. Marr, Portland, OR (US); Dion Rodgers, Hillsboro, OR (US); David L. Hill, Cornelius, OR (US); Shiv Kaushik, Portland, OR (US); James B. Crossland, Banks, OR (US); David A. Koufaty, Portland, OR (US)

Correspondence Address: Jeffrey S. Draeger, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/039,777

(22) Filed: Dec. 31, 2001

(51) Int. Cl. G06F 9/00

(52) U.S. Cl. 712/235; 712/228

(57) ABSTRACT

Techniques for suspending execution of a thread in a multi-threaded processor. In one embodiment, a processor includes resources that can be partitioned between multiple threads. Processor logic receives an instruction in a first thread of execution, and, in response to that instruction, relinquishes portions of the portioned resources for use by other threads.

### RELATED APPLICATIONS

This application is related to application Ser. No. ______ entitled “A Method and Apparatus for Suspending Execution of a Thread Until a Specified Memory Access Occurs”; application Ser. No. ______, entitled “Coherency Techniques for Suspending Execution of a Thread Until a Specified Memory Access Occurs”; application Ser. No. ______, entitled “Instruction Sequences for Suspending Execution of a Thread Until a Specified Memory Access Occurs” all filed on the same date as the present application.

### BACKGROUND

1. Field

The present disclosure pertains to the field of processors. More particularly, the present disclosure pertains to multi-threaded processors and techniques for temporarily suspending the processing of one thread in a multi-threaded processor.

2. Description of Related Art

A multi-threaded processor is capable of processing multiple different instruction sequences concurrently. A primary motivating factor driving execution of multiple instruction streams within a single processor is the resulting improvement in processor utilization. Highly parallel architectures have developed over the years, but it is often difficult to extract sufficient parallelism from a single stream of instructions to utilize the multiple execution units. Simultaneous multi-threading processors allow multiple instruction streams to execute concurrently in the different execution resources in an attempt to better utilize those resources. Multi-threading can be particularly advantageous for programs that encounter high latency delays or which often wait for events to occur. When one thread is waiting for a high latency task to complete or for a particular event, a different thread may be processed.

Many different techniques have been proposed to control when a processor switches between threads. For example, some processors detect particular long latency events such as L2 cache misses and switch threads in response to these detected long latency events. While detection of such long latency events may be effective in some circumstances, such event detection is unlikely to detect all points at which it may be efficient to switch threads. In particular, event based thread switching may fail to detect points in a program where delays are intended by the programmer.

In fact, often, the programmer is in the best position to determine when it would be efficient to switch threads to avoid wasteful spin-wait loops or other resource-consuming delay techniques. Thus, allowing programs to control thread switching may enable programs to operate more efficiently. Explicit program instructions that affect thread selection may be advantageous to this end. For example, a “Pause” instruction is described in U.S. patent application No. 09/489,130, filed Jan. 21, 2000. The Pause instruction allows a thread of execution to be temporarily suspended either until a count is reached or until an instruction has passed through the processor pipeline. The Pause instruction described in the above-referenced application, however, does not specify that thread partitionable are to be relinquished. Different techniques may be useful in allowing programmers to more efficiently harness the resources of a multi-threaded processor.

### BRIEF DESCRIPTION OF THE FIGURES

The present invention is illustrated by way of example and not limitation in the Figures of the accompanying drawings.

FIG. 1 illustrates one embodiment of a multi-threaded processor having logic to suspend a thread in response to an instruction and to relinquish resources associated with that thread.

FIG. 2 is a flow diagram illustrating operation of the multi-threaded processor of FIG. 1 according to one embodiment.

FIG. 3a illustrates various options for specifying an amount of time a multi-threading processor may be suspended.

FIG. 3b illustrates a flow diagram in which the suspended state may be exited by either the elapse of a selected amount of time or the occurrence of an event.

FIG. 4 illustrates resource patititioning, sharing, and duplication according to one embodiment.

FIG. 5 illustrates various design representations or formats for simulation, emulation, and fabrication of a design using the disclosed techniques.

### DETAILED DESCRIPTION

The following description describes techniques for suspending execution of a thread in a multi-threaded processor. In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

The disclosed techniques may allow a programmer to implement a suspend mechanism in one thread while letting other threads harness processing resources. Thus, partitions previously dedicated to the suspended thread may be relinquished while the thread is suspended. These and/or other disclosed techniques may advantageously improve overall processor throughput.

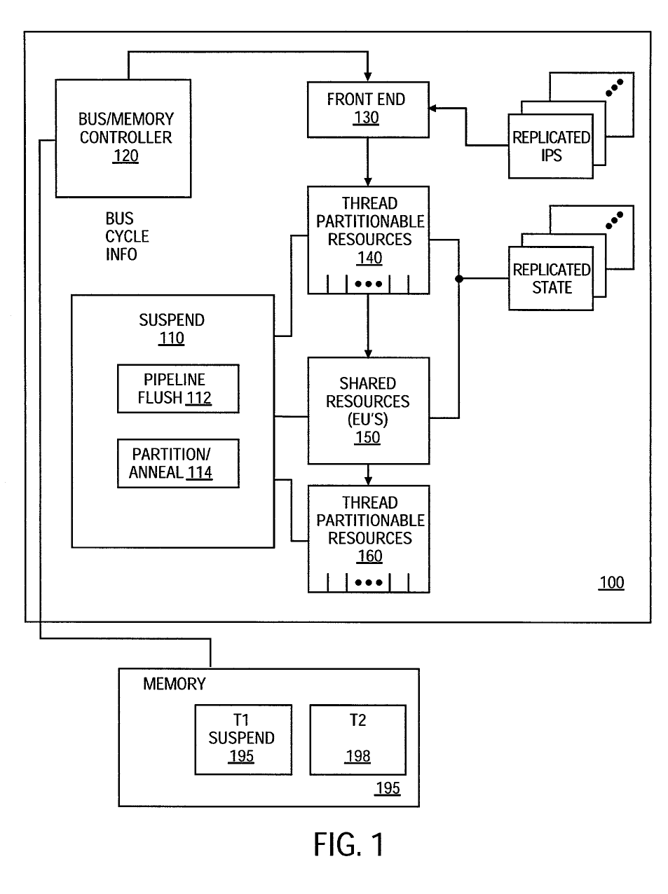

FIG. 1 illustrates one embodiment of a multi-threaded processor 100 having suspend logic 110 to allow a thread to be suspended in response to an instruction. A “processor” may be formed as a single integrated circuit in some embodiments. In other embodiments, multiple integrated circuits may together form a processor, and in yet other embodiments hardware and software routines (e.g., binary translation routines) may together form the processor. The suspend logic may be microcode, various forms of control logic, or other implementation of the described functionality, possibly including translation, software, etc.

The processor 100 is coupled to a memory 195 to allow the processor to retrieve instructions from the memory 195 and to execute these instructions. The memory and the processor may be coupled in a point-to-point fashion, via bus bridges, via a memory controller or via other known or otherwise available techniques. The memory 195 stores various program threads, including a first thread 196 and a second thread 198. The first thread 196 includes a SUSPEND instruction.

In the embodiment of FIG. 1, a bus/memory controller 120 provides instructions for execution to a front end 130. The front end 130 directs the retrieval of instructions from various threads according to instruction pointers 170. Instruction pointer logic is replicated to support multiple threads. The front end 130 feeds instructions into thread partitionable resources 140 for further processing. The thread partitionable resources 140 include logically separated partitions dedicated to particular threads when multiple threads are active within the processor 100. In one embodiment, each separate partition only contains instructions from the thread to which that portion is dedicated. The thread partitionable resources 140 may include, for example, instruction queues. When in a single thread mode, the partitions of the thread partitionable resources 140 may be combined to form a single large partition dedicated to the one thread.

The processor 100 also includes replicated state 180. The replicated state 180 includes state variables sufficient to maintain context for a logical processor. With replicated state 180, multiple threads can execute without competition for state variable storage. Additionally, register allocation logic may be replicated for each thread. The replicated state-related logic operates with the appropriate resource partitions to prepare incoming instructions for execution.

The thread partitionable resources 140 pass instructions along to shared resources 150. The shared resources 150 operate on instructions without regard to their origin. For example, scheduler and execution units may be thread-unaware shared resources. The partitionable resources 140 may feed instructions from multiple threads to the shared resources 150 by alternating between the threads in a fair manner that provides continued progress on each active thread. Thus, the shared resources may execute the provided instructions on the appropriate state without concern for the thread mix.

The shared resources 150 may be followed by another set of thread partitionable resources 160. The thread partitionable resources 160 may include retirement resources such as a re-order buffer and the like. Accordingly, the thread partitionable resources 160 may ensure that execution of instructions from each thread concludes properly and that the appropriate state for that thread is appropriately updated.

As previously mentioned, it may be desirable to provide programmers with a technique to implement a delay without requiring constant polling of a memory location or even execution of a loop of instructions. Thus, the processor 100 of FIG. 1 includes the suspend logic 110. The suspend logic 110 may be programmable to provide a particular duration for which the thread is to be suspended or to provide a fixed delay. The suspend logic 110 includes pipeline flush logic 112 and partition/anneal logic 114.

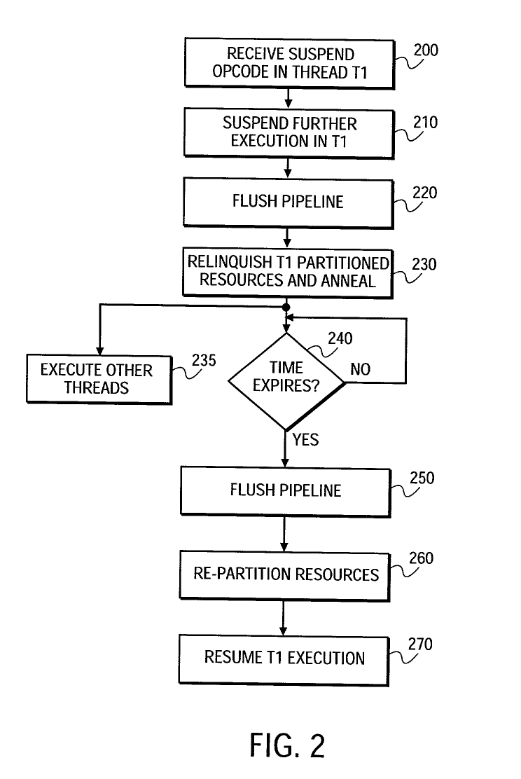

The operations of the embodiment of FIG. 1 may be further explained with reference to the flow diagram of FIG. 2. In one embodiment, the instruction set of the processor 100 includes a SUSPEND opcode (instruction) to cause thread suspension. In block 200, the SUSPEND opcode is received as a part of the sequence of instructions of a first thread (T1). Thread T1 execution is suspended as indicated in block 210. The thread suspend logic 110 includes pipeline flush logic 112, which drains the processor pipeline in order to clear all instructions as indicated in block 220. In one embodiment, once the pipeline has been drained, partition/anneal logic 114 causes any partitioned resources associated exclusively with thread T1 to be relinquished for use by other threads as indicated in block 230. These relinquished resources are annealed to form a set of larger resources for the remaining active threads to utilize.

As indicated in block 235, other threads may be executed (assuming instructions are available for execution) during the time in which thread T1 is suspended. Thus, processor resources may continue to be utilized, substantially without interference from thread T1. Dedication of the processor resources more fully to other threads may advantageously expedite processing of other useful execution streams when thread T1 has little or no useful work to accomplish, or when a program decides that completing tasks in thread T1 is not a priority.

In general, with thread T1 suspended, the processor enters an implementation dependent state which allows other threads to more fully utilize the processor resources. In some embodiments, the processor may relinquish some or all of the partitions of partitionable resources 140 and 160 that were dedicated to T1. In other embodiments, different permutations of the SUSPEND opcode or settings associated therewith may indicate which resources to relinquish, if any. For example, when a programmer anticipates a shorter wait, the thread may be suspended, but maintain most resource partitions. Throughput is still enhanced because the shared resources may be used exclusively by other threads during the thread suspension period. When a longer wait is anticipated, relinquishing all partitions associated with the suspended thread allows other threads to have additional resources, potentially increasing the throughput of the other threads. The additional throughput, however, comes at the cost of the overhead associated with removing and adding partitions when threads are respectively suspended and resumed.

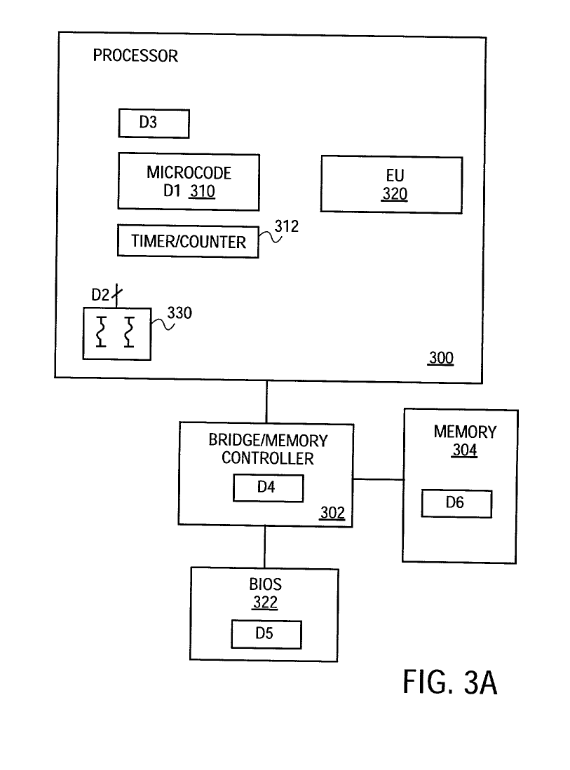

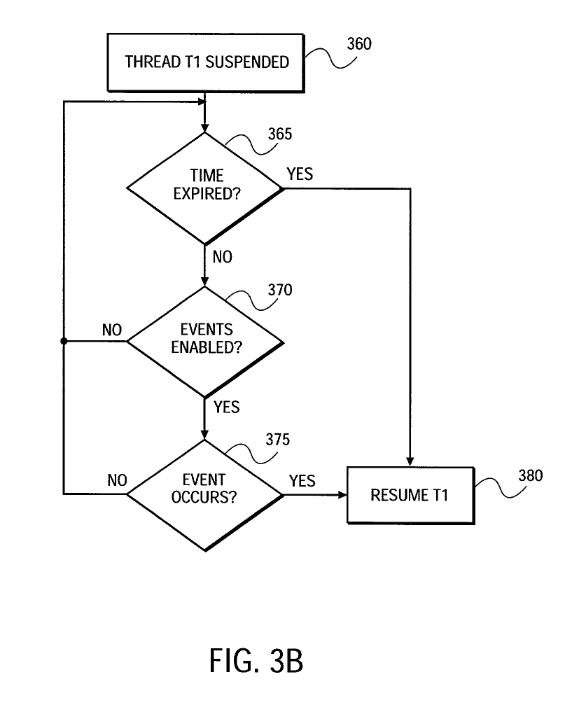

In block 240, a test is performed to determine if the suspend state should be exited. If the specified delay has occurred (i.e., sufficient time has elapsed), then the thread may be resumed. The time for which the thread is suspended may be specified in a number of manners, as shown in FIG. 3a. For example, a processor 300 may include a delay time (D1) specified by a routine of microcode 310. A timer or counter 312 may implement the delay and signal the microcode when the specified amount of time has elapsed. Alternatively, one or more fuses 330 may be used to specify a delay (D2), or a register 340 may store a delay (D3). A delay (D4) may be specified by a register or storage location such as a configuration register in a bridge or memory controller 302 which is coupled to the processor. A delay (D5) may also be specified by the basic input/output system (BIOS) 322. Alternatively still, the delay (D6) could be stored in a memory 304 which is coupled to the memory controller 302. The processor 300 may retrieve the delay value as an implicit or explicit operand to the SUSPEND opcode as it is executed by an execution unit 320. Other known or otherwise available or convenient techniques of specifying a value may be used to specify the delay as well.

Referring back to FIG. 2, if the delay time has not elapsed, then the timer, counter, or other delay-measuring mechanism used continues to track the delay, and the thread remains suspended, as indicated by the return to block 240. If the delay time has elapsed, then thread T1 resumption begins in block 250. As indicated in block 250, the pipeline is flushed, to free resources for thread T1. In block 260, resources are repartitioned such that thread T1 has portions of the thread-partitionable resources with which to perform operations. Finally, thread T1 re-starts execution, as indicated in block 270.

Thus, the embodiments of FIGS. 1 and 2 provide techniques to allow a thread to be suspended by a program for a particular duration. In one embodiment, other events also cause T1 to be resumed. For example, an interrupt may cause T1 to resume. FIG. 3b illustrates a flow diagram for one embodiment that allows other events to cause the suspend state to be exited. In block 360, the thread is already suspended according to previous operations. In block 370, whether sufficient time has elapsed (as previously discussed with respect to FIG. 2) is tested. In the event that sufficient time has elapsed, then thread T1 is resumed, as indicated in block 380.

On the other hand, if insufficient time has elapsed in block 365, then any suspend-state-breaking events are detected in blocks 370 and 375. In some embodiments, there may be operands, configuration setting, permutations of the SUSPEND instruction, etc., that specify which if any events cause the suspend state to be exited. Thus, block 370 tests whether any (and in some embodiments which) events are enabled to break the suspend state. If no events are enabled to break the suspend state, then the process returns to block 365. If any of the enabled events occurs, as tested in block 375, then thread T1 is resumed, as indicated in block 380. Otherwise, the processor remains with thread T1 in the suspended state, and the process returns to block 365.

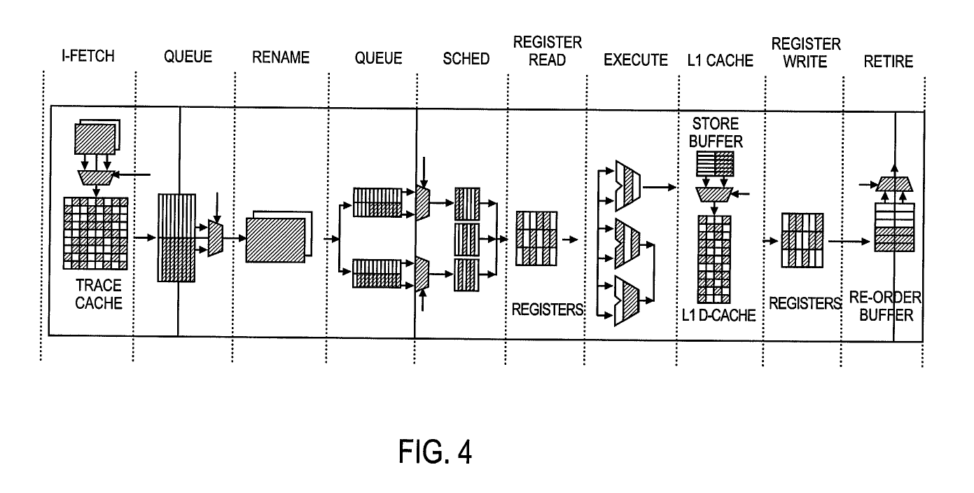

FIG. 4 illustrates the partitioning, duplication, and sharing of resources according to one embodiment. Partitioned resources may be partitioned and annealed (fused back together for re-use by other threads) according to the ebb and flow of active threads in the machine. In the embodiment of FIG. 4, duplicated resources include instruction pointer logic in the instruction fetch portion of the pipeline, register renaming logic in the rename portion of the pipeline, state variables (not shown, but referenced in various stages in the pipeline), and an interrupt controller (not shown, generally asynchronous to pipeline). Shared resources in the embodiment of FIG. 4 include schedulers in the schedule stage of the pipeline, a pool of registers in the register read and write portions of the pipeline, execution resources in the execute portion of the pipeline. Additionally, a trace cache and an L1 data cache may be shared resources populated according to memory accesses without regard to thread context. In other embodiments, consideration of thread context may be used in caching decisions. Partitioned resources in the embodiment of FIG. 4, include two queues in queuing stages of the pipeline, a reorder buffer in a retirement stage of the pipeline, and a store buffer. Thread selection multiplexing logic alternates between the various duplicated and partitioned resources to provide reasonable access to both threads.

In the embodiment of FIG. 4, when one thread is suspended, all instructions related to thread 1 are drained from both queues. Each pair of queues is then combined to provide a larger queue to the second thread. Similarly, more registers from the register pool are made available to the second thread, more entries from the store buffer are freed for the second thread, and more entries in the re-order buffer are made available to the second thread. In essence, these structures are returned to single dedicated structures of twice the size. Of course, different proportions may result from implementations using different numbers of threads.

In some embodiments, the thread partitionable resources, the replicated resources, and the shared resources may be arranged differently. In some embodiments, there may not be partitionable resources on both ends of the shared resources. In some embodiments, the partitionable resources may not be strictly partitioned, but rather may allow some instructions to cross partitions or may allow partitions to vary in size depending on the thread being executed in that partition or the total number of threads being executed. Additionally, different mixes of resources may be designated as shared, duplicated, and partitioned resources.

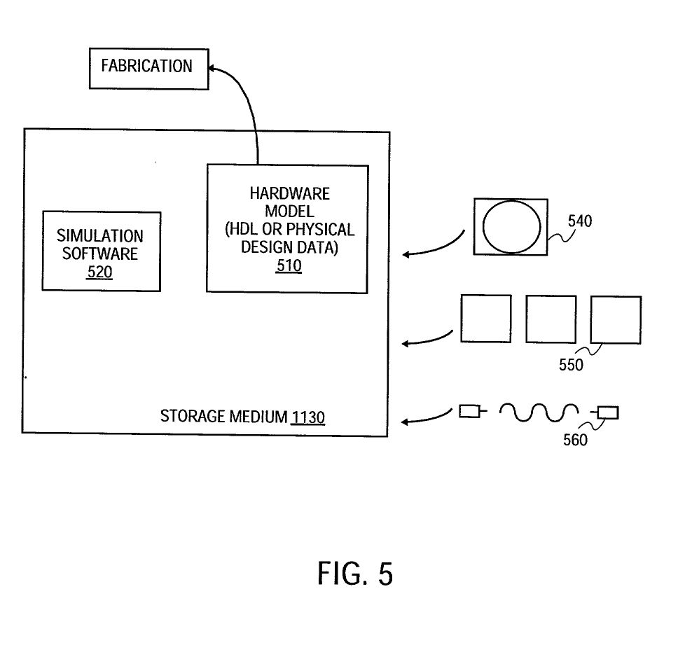

FIG. 5 illustrates various design representations or formats for simulation, emulation, and fabrication of a design using the disclosed techniques. Data representing a design may represent the design in a number of manners. First, as is useful in simulations, the hardware may be represented using a hardware description language or another functional description language which essentially provides a computerized model of how the designed hardware is expected to perform. The hardware model 1110 may be stored in a storage medium 1100 such as a computer memory so that the model may be simulated using simulation software 1120 that applies a particular test suite 1130 to the hardware model 1110 to determine if it indeed functions as intended. In some embodiments, the simulation software is not recorded, captured, or contained in the medium.

Additionally, a circuit level model with logic and/or transistor gates may be produced at some stages of the design process. This model may be similarly simulated, sometimes by dedicated hardware simulators that form the model using programmable logic. This type of simulation, taken a degree further, may be an emulation technique. In any case, re-configurable hardware is another embodiment that may involve a machine readable medium storing a model employing the disclosed techniques.

Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. Again, this data representing the integrated circuit embodies the techniques disclosed in that the circuitry or logic in the data can be simulated or fabricated to perform these techniques.

In any representation of the design, the data may be stored in any form of a computer readable medium. An optical or electrical wave 1160 modulated or otherwise generated to transmit such information, a memory 1150, or a magnetic or optical storage 1140 such as a disc may be the medium. The set of bits describing the design or the particular part of the design are an article that may be sold in and of itself or used by others for further design or fabrication.

Thus, techniques for suspending execution of a thread in a multi-threaded processor are disclosed. While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art upon studying this disclosure.

What is claimed is:

1. A processor comprising:
a plurality of thread partitionable resources that are each partitionable between a plurality of threads;
logic to receive a program instruction from a first thread of said plurality of threads, and in response to said program instruction to cause the processor to suspend execution of the first thread and to relinquish portions of said plurality of thread partitionable resources associated with the first thread for use by other ones of said plurality of threads.

2. The processor of claim 1 wherein the program instruction is a suspend instruction.

3. The processor of claim 1 wherein said logic is to cause the processor to suspend the first thread for a selected amount of time.

4. The processor of claim 3 wherein said selected amount of time is a fixed amount of time.

5. The processor of claim 3 wherein said processor is to execute instructions from a second thread while said first thread is suspended.

6. The processor of claim 3 wherein said selected amount of time is programmable by at least one technique chosen from a set consisting of:
providing an operand in conjunction with the program instruction;
blowing fuses to set the selected amount;
programming the selected amount in a storage location in advance of decoding the program instruction;
setting the selected amount in microcode.

7. The processor of claim 1 wherein said plurality of thread partitionable resources comprises:
an instruction queue;
a register pool.

8. The processor of claim 7 further comprising:
a plurality of shared resources, said plurality of shared resources comprising:
a plurality of execution units;
a cache;
a scheduler;
a plurality of duplicated resources, said plurality of duplicated resources comprising:
a plurality of processor state variables;
an instruction pointer;
register renaming logic.

9. The processor of claim 8 wherein said plurality of thread partitionable resources further comprises:
a plurality of re-order buffers;
a plurality of store buffer entries.

10. The processor of claim 1 wherein said logic is further to cause the processor to resume execution of said first thread in response to an event.

11. The processor of claim 3 wherein said logic is further to cause the processor to ignore events until said selected amount of time has elapsed.

12. The processor of claim 1 wherein said processor is embodied in digital format on a computer readable medium.

13. A method comprising:
receiving a first opcode in a first thread of execution;
suspending said first thread for a selected amount of time in response to said first opcode;
relinquishing a plurality of thread partitionable resources in response to said first opcode.

14. The method of claim 13 wherein relinquishing comprises:
annealing the plurality of thread partitionable resources to become larger
structures usable by fewer threads.

15. The method of claim 14 wherein relinquishing said plurality of thread partitionable resources comprises:
relinquishing a partition of an instruction queue;
relinquishing a plurality of registers from a register pool.

16. The method of claim 15 wherein relinquishing said plurality of thread partitionable resources further comprises:
relinquishing a plurality of store buffer entries;
relinquishing a plurality of re-order buffer entries.

17. The method of claim 13 wherein said selected amount of time is programmable by at least one technique chosen from a set consisting of:
providing an operand in conjunction with the first opcode;
blowing fuses to set the selected amount of time;
programming the selected amount of time in a storage location in advance of decoding the program instruction;
setting the selected amount of time in microcode.

18. A system comprising:
a memory to store a plurality of program threads, including a first thread and a second thread, said first thread including a first instruction;
a processor coupled to said memory, said processor including a plurality of thread partitionable resources and a plurality of shared resources, said processor to execute instructions from said memory, said processor, in response to execution of said first instruction to suspend said first thread and to relinquish portions of said plurality of thread partitionable resources.

19. The system of claim 18 wherein said processor is to execute said second thread from said memory while said first thread is suspended.

20. The system of claim 19 wherein said processor is to suspend execution of said first thread in response to said first instruction for a selected amount of time, said selected amount of time is chosen by at least one technique chosen from a set consisting of:
providing an operand in conjunction with the program instruction;
blowing fuses to set the selected amount of time;
programming the selected amount of time in a storage location in advance of decoding the program instruction;
setting the select amount of time in microcode.

21. The system of claim 18 wherein said plurality of thread partitionable resources comprises:
an instruction queue;
a register pool.

22. The system of claim 21 wherein said processor further comprises:
a plurality of shared resources, said plurality of shared resources comprising:
a plurality of execution units;
a cache;
a scheduler;
a plurality of duplicated resources, said plurality of duplicated resources comprising:
a plurality of processor state variables;
an instruction pointer;
register renaming logic.

23. The system of claim 22 wherein said plurality of thread partitionable resources further comprises:
a plurality of re-order buffers;
a plurality of store buffer entries;

24. An apparatus comprising:
means for receiving a first instruction from a first thread;
means for suspending said first thread in response to said first instruction;
means for relinquishing a plurality of partitions of a plurality of resources;
means for re-partitioning said plurality of resources after a selected amount of time.

25. The apparatus of claim 24 wherein said first instruction is a macro-instruction from a user-executable program.

26. The apparatus of claim 25 wherein said plurality of resources comprises a register pool and an instruction queue.
